(19) United States
(12) Patent Application Publication
(10) Pub. No.: US 2011/0106576 A1
(43) Pub. Date: May 5, 2011

(54) EQUIPMENT MANAGEMENT DEVICE AND METHOD

(75) Inventors: KUEI-CHIH HOU, Tu-Cheng (TW); YU-CHI TSAI, Tu-Cheng (TW)

(73) Assignee: HON HAI PRECISION INDUSTRY CO., LTD., Tu-Cheng (TW)

(21) Appl. No.: 12/755,436

(22) Filed: Apr. 7, 2010

(30) Foreign Application Priority Data
Oct. 29, 2009 (CN) 200910309047.5

(51) Int. Cl. G06Q 10/00

(52) U.S. Cl. 705/7.12; 705/5

(57) ABSTRACT

In a management method for equipment in multiple locations using a device, an application form is generated according to reservation of an equipment item if the item is available, and it is determined whether another reservation has been made for the equipment item after the schedule time, assigns the equipment item accordingly, locates the equipment item, and issues notification of the status information and location of the equipment on an electronic device.

### BACKGROUND

1. Technical Field

Embodiments of the present disclosure relate to management devices and methods, and more particularly to an equipment management device and a method executed by the device.

2. Description of Related Art

Equipment, such as that employed by operators, is often shared among multiple locations, which causes the equipment management inefficiency. For example, multiple shared locations affect operational efficiency of the need for operational assignment, device location, regular maintenance, and other problems.

What is needed, therefore, is an equipment management device and method capable of overcoming the limitations described.

### BRIEF DESCRIPTION OF THE DRAWINGS

FIG. 1 is a block diagram of one embodiment of an equipment management device as disclosed connected over a network to some electronic devices.

FIG. 2 is a schematic diagram of an exemplary number of locations with shared equipment items therein.

FIG. 3 is a block diagram of an equipment item.

FIG. 4 is a block diagram of one embodiment of a management unit of the device in FIG. 1.

FIG. 5 is a flowchart illustrating one embodiment of an equipment management method as disclosed.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

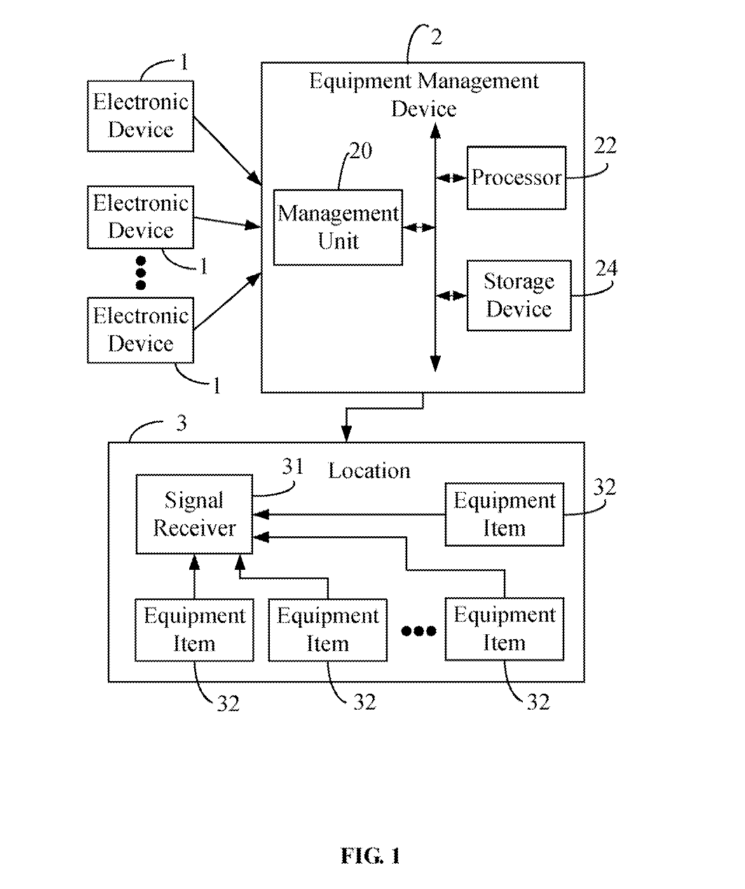

FIG. 1 is a block diagram of one embodiment of an equipment management device 2 as disclosed connected over a network to one or more electronic devices 1 over a network. Three electronic devices 1 are shown, each providing an operating interface via which an equipment reservation can be made. The device 2 receives reservations from the operating interface, and generates an application form stating a time for the reservation which does not conflict with other reservations. The device 2 detects a usage status and location of each equipment item 32 according to an ID of the equipment item 32, i.e., the device 2 determines whether the equipment item 32 is available, and searches for an IP address of a location 3 from the network at which the equipment item 32 is located. Depending on the result, the device 2 can reserve the equipment item 32 when available, and issue notification of the usage status and the location of the equipment item 32 on the operating interface of the one or more electronic devices 1. In FIG. 1, four equipment items 32 are located at the location 3. While the disclosure can accommodate a plurality of equipment items 32, only four equipment items 32 are shown in the examples. In one embodiment, the device 2 may be a mobile phone, a personal computer, or a server, for example.

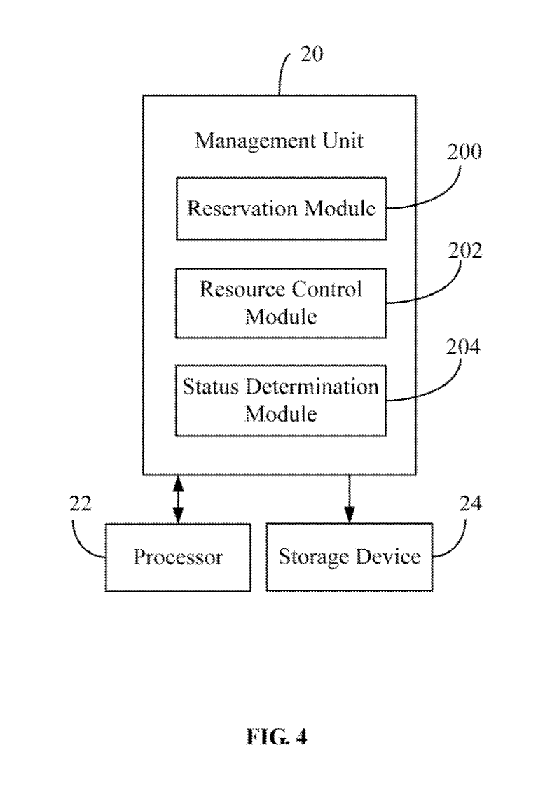

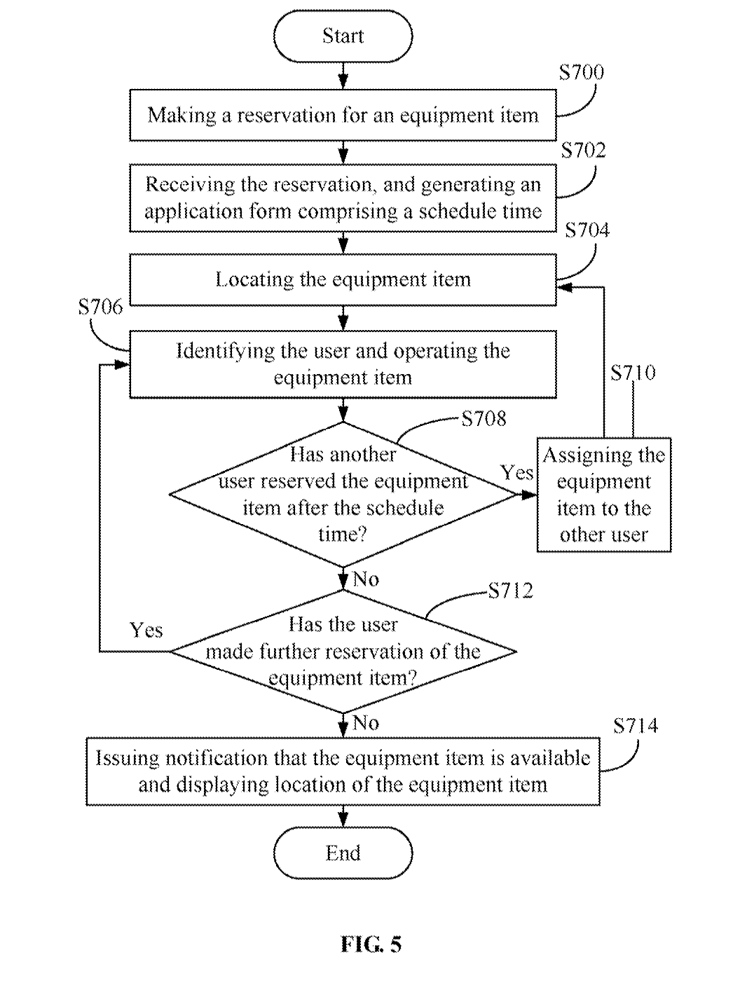

In one embodiment, the device 2 includes a management unit 20, at least one processor 22, and a storage device 24. The at least one processor 22 executes one or more computerized operations of the management unit 20 that may be stored in the storage device 24. The storage device 24 may be a hard disk drive, a compact disc, a digital video disc, or a tape drive, for example. In order to clearly illustrate the embodiment, more functions of the management unit 20 are detailed as follows as shown in FIGS. 4-7.

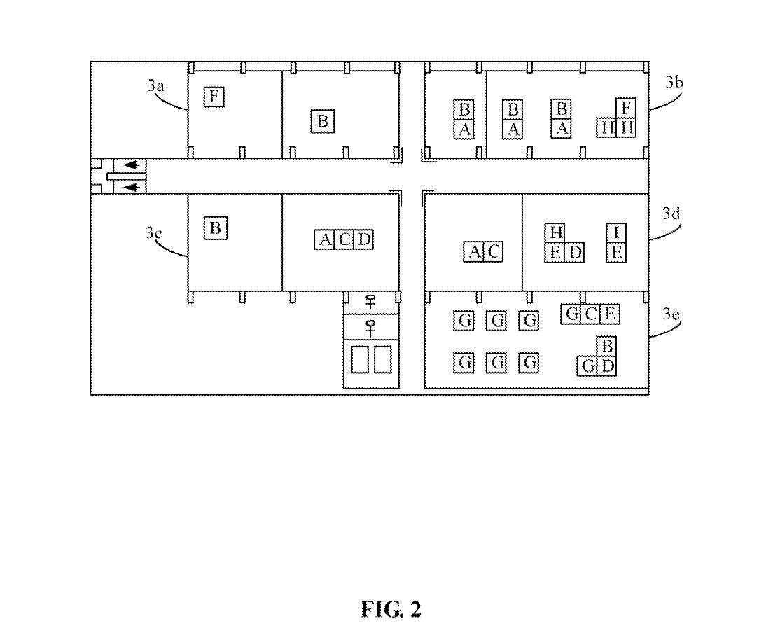

FIG. 2 is a schematic diagram of an exemplary number of locations with shared equipment items 32 therein. Five locations, “3a,” “3b,” “3c,” “3d,” and “3e” are shown in FIG. 2. Each of the five locations has one or more equipment items 32 located therein. Each of the equipment items 32 is identified by, for example, a barcode label or other device, and each of the five locations has an IP address assigned on the network and is furnished with a signal receiver 31 as shown in FIG. 1.

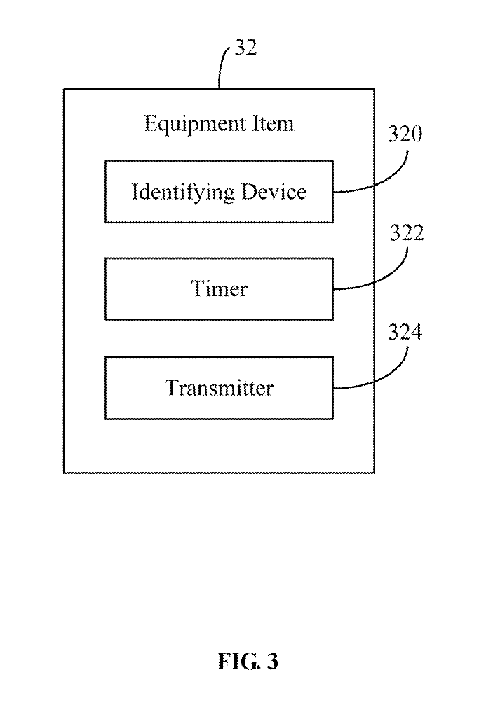

FIG. 3 is a block diagram of one of the equipment items 32. The equipment item 32 includes an identifying device 320, a timer 322, and a transmitter 324. The identifying device 320 may be a radio frequency identification (RFID) reader with ID card reading capability. After ID acceptance by the identifying device 320, the equipment item 32 is operated, and the timer 322 records time period the equipment item 32 is to be used. The transmitter 324 transmits corresponding status information to the signal receiver 31, and generates location of the equipment item 32 according to the ID of the equipment item 32 and the IP address of the location 3, which is then transmitted to the signal receiver 31. The signal receiver 31 transmits the status information and the location of the equipment item 32 to the device 2.

FIG. 4 is a block diagram of one embodiment of the management unit 20 of the device 2 comprising function modules. In one embodiment, the managing unit 20 may include a reservation module 200, a resource control module 202, and a status determination module 204. One or more computerized codes of the modules 200-204 may be executed by the processor 22 to manage each equipment item 32 in each location 3.

The reservation module 200 is operable to record the status information and the location of each equipment item 32. The reservation module 200 is further operable to receive a reservation request for an equipment item 32 from a first user, and generate an application form according to the request when a schedule time of the request does not conflict with other equipment reservations. The application form is saved in the storage device 24.

In one embodiment, if a second user has reserved the equipment item 32 after the schedule time of the reservation from the first user, the processor 22 directs the resource control module 202 to locate all application forms stored in the storage device 24, to determine any conflicts. For example, if the second user plans to operate the equipment item 32 from nine o'clock to eleven o'clock, and another user plans to operate the equipment item 32 from ten o'clock to eleven o'clock, the processor 22 can output a message on the operating interface of the one or more electronic devices 1 to suggest that the second user reserves another time. If no conflicts are found, the resource control module 202 detects all application forms related to the equipment item 32 in the storage device 24 and acquires location of the equipment item 32, to reserve the equipment item 32 for the second user. Otherwise, if another user has not reserved the equipment item 32 and the first user has further reserved the equipment item 32 after the schedule time of the reservation request from the first user, the processor 22 controls the resource control module 202 to assign the equipment item 32 to the first user.

The status determination module 204 is operable to issue notification of the status information of each equipment item 32. For example, if the equipment item 32 is in use, the status determination module 204 issues notification that the equipment item 32 is in use, or if the first user has not further reserved the equipment item 32 and nobody has reserved the equipment item 32 after the schedule time, the status determination module 204 issues notification that the equipment item 32 is available. The status determination module 204 further displays the location of the equipment item 32 on the operating interface of the one or more electronic devices 1.

FIG. 7 is a flowchart illustrating one embodiment of a method for managing equipment items 32 in different locations 3 executed by a device 2. One exemplary equipment item 32 is here managed by the device 2.

In block 5700, a reservation is made for the equipment item 32 via an operating interface of the electronic device 1.

In block 5702, the reservation module 200 receives the reservation, and generates an application form comprising a schedule time according to the reservation when the schedule time of the reservation does not conflict with other reservations of the equipment item 32. The application form is stored in the storage device 24.

In block S704, the resource control module 202 detects all application forms related to the equipment item 32 from the storage device 24 and detects location of the equipment item 32 recorded in the reservation module 200, so as to locate the equipment item 32. Here, the resource control module 202 detects that equipment item 32 is in location 3a.

In block S706, the identifying device 320 installed on the equipment item 32, identifies the user by scanning an ID thereof. The equipment item 32 is now in use within the schedule time. Timer 322 of the equipment item 32 measures the elapsed time equipment item 32 is in use, and the transmitter 324 of the equipment item 32 transmits status information of the equipment item 32 to the signal receiver 31 installed in the location 3a within the operating time. According to the ID of the equipment item 32 and the IP address of the location 3a, location information of the equipment item 32 is generated, and transmitter 324 also transmits the location of the equipment item 32 to the signal receiver 31. The reservation module 200 records the status information and the location of the equipment item 32, and the status determination module 204 issues notification that the equipment item 32 is in use.

In block S708, the resource control module 202 determines whether another user has reserved the equipment item 32 after the schedule time of the user. If so, block S710 is implemented. If not, block S712 is implemented.

In block S710, the resource control module 202 assigns the equipment item 32 to the other user, and block S704 is repeated.

In block S712, according to the application forms of the storage device 24, the resource control module 202 determines whether the user of block S700 has further reserved the equipment item 32 after the schedule time. If so, the resource control module 202 assigns the equipment item 32 to the user of block S700, and block S706 is implemented. If not, block S714 is implemented.

In block S714, the status determination module 204 issues notification that the equipment item 32 is available, and displays the location thereof on the operating interface of the electronic device 1.

With the method of FIG. 7, each equipment item 32 in different locations 3 can be managed by the device 2, with usage status and location of each equipment item 32, available therefrom, and use reservation enabled with no conflict.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A device for managing equipment in multiple locations, comprising:
at least one processor;
a storage device; and
a management unit stored in the storage device and executed by the at least one processor, the management unit comprising:
a reservation module operable to receive a first reservation of an equipment item, generate an application form comprising a schedule time according to the first reservation if the equipment item is available, and store the application form in the storage device;
a resource control module operable to locate the equipment item according to application forms stored in the storage device and location of the equipment item, make a second reservation after the schedule time if a reservation by another has been requested, or continue the first reservation after the schedule time if such continuation has been requested and no reservation by another has been requested; and
a status determination module operable to issue notification that the equipment item is in use during the schedule time, and issue notification that the equipment is available and display location of the equipment item after the schedule time, if no continuation has been requested and no reservation by another has been requested.

2. The device as described in claim 1, wherein each location hosts a signal receiver for retrieving status information of all equipment items in the location.

3. The device as described in claim 2, wherein each equipment item to be managed comprises:
an identifying device operable to identify a user;
a timer operable to measure elapsed operation time; and
a transmitter operable to transmit status information of the equipment item to the signal receiver within the operation time, and transmit location information of the equipment item according to ID of the equipment item and IP address of the location to the signal receiver.

4. The device as described in claim 3, wherein the status determination module is further operable to receive the status information and the location of each equipment item, and issue notification of each equipment item to the electronic device.

5. The device as described in claim 3, wherein the status determination module is further operable to calculate a usage ratio for each equipment item, and generate a report for indicating the usage ratio of each equipment item.

6. A method for managing equipment in multiple locations, the method comprising:
generating an application form according to a first request for reservation of an equipment item and saving the application form in a storage device if a schedule time of the reservation does not conflict with other reservations for the equipment item;
locating the requested equipment item according to application forms stored in the storage device and location of the equipment item;
operating the equipment item within the schedule time; and
if a second reservation has been made by another for the equipment item after the schedule time, assigning the equipment item accordingly and locating the equipment item; or
if no other reservation of the equipment item has been made after the schedule time, and the first reservation has been extended to after the schedule time, assigning the equipment item accordingly and continuing the operation; or
if no further reservation has been made by another nor the current reservation has been extended, issuing notification that the equipment item is available and displaying the location of the equipment item on an electronic device.

7. The method as described in claim 6, wherein each location hosts a signal receiver for receiving status information of all equipment items in the location.

8. The method as described in claim 7, wherein operation of the equipment item further comprises:
identifying a user;
measuring elapsed operating time;
transmitting status information of the equipment item to the signal receiver within the operating time;
generating location of the equipment item according to ID thereof and an IP address of the location; and
transmitting the location of the equipment item to the signal receiver.

9. The method as described in claim 8, further comprising:
receiving the status information and the location of each equipment item; and
issuing notification of the status information and the location of each equipment item on the electronic device.

10. The method as described in claim 6, further comprising:
calculating a usage ratio for each equipment item; and
generating a report to indicate the usage ratio of each equipment item.

11. A storage medium having stored thereon instructions that, when executed by a processor of a device, causing the device to perform a method of managing equipment in multiple locations, the method comprising:
generating an application form according to a first request for reservation of an equipment item and saving the application form in a storage device if a schedule time of the reservation does not conflict with other reservations for the equipment item;
locating the requested equipment item according to application forms stored in the storage device and location of the equipment item;
operating the equipment item within the schedule time; and
if a second reservation has been made by another for the equipment item after the schedule time, assigning the equipment item accordingly and locating the equipment item; or
if no other reservation of the equipment item has been made after the schedule time, and the first reservation has been extended to after the schedule time, assigning the equipment item accordingly and continuing the operation; or
if no further reservation has been made by another nor the current reservation has been extended, issuing notification that the equipment item is available and displaying the location of the equipment item on an electronic device.

12. The storage medium as claimed in claim 11, wherein each location hosts a signal receiver for receiving status information of all equipment items in the location.

13. The storage medium as described in claim 12, wherein operation of the equipment item further comprises:
identifying a user;
measuring elapsed operating time;
transmitting status information of the equipment item to the signal receiver within the operating time;
generating location of the equipment item according to ID thereof and an IP address of the location; and
transmitting the location of the equipment item to the signal receiver.

14. The storage medium as described in claim 13, wherein the method further comprises:
receiving the status information and the location of each equipment item; and
issuing notification of the status information and the location of each equipment item on the electronic device.

15. The storage medium as described in claim 11, wherein the method further comprises:
calculating a usage ratio for each equipment item; and
generating a report to indicate the usage ratio of each equipment item.
